(19) United States
(12) Patent Application Publication
(10) Pub. No.: US 2016/0342306 A1
(43) Pub. Date: Nov. 24, 2016

(54) ELECTRONIC DEVICE AND METHOD FOR CHANGING APPLICATION ICON

(71) Applicant: FIH (HONG KONG) LIMITED, Kowloon (HK)

(72) Inventor: WAN-LING HO, New Taipei (TW)

(21) Appl. No.: 14/796,086

(22) Filed: Jul. 10, 2015

(30) Foreign Application Priority Data
May 22, 2015 (TW) 104116582

(51) Int. Cl. G06F 3/0481; G06F 3/0488

(52) U.S. Cl. CPC G06F 3/04817; G06F 3/0488

(57) ABSTRACT

An electronic device includes a touch screen, a processor, and a storage. The storage stores one or more programs executed by the processor, the one or more programs includes a database, a selection module, a preview module, and a changing module. The database stores at least one stand-by icon. The selection module selects at least one application icon displayed on the touch screen according to a first touch operation. The preview module switches the at least one stand-by icon stored in the database to be previewed in a predetermined area according to a second touch operation. The changing module changes the at least one application icon selected by the selection module to the at least one stand-by icon previewed on the predetermined area according to a third touch operation.

### CROSS-REFERENCE TO RELATED APPLICATIONS

This application claims priority to Taiwanese Patent Application No. 104116582 filed on May 22, 2015, the contents of which are incorporated by reference herein.

### FIELD

The subject matter herein generally relates to an electronic device and a method for changing application icons displayed on a touch screen of the electronic device.

### BACKGROUND

Electronic devices, such as laptop computers, smart phones, and personal digital assistants (PDAs), are becoming more and more popular. A plurality of customized applications (APPs) can be selectively installed in the electronic devices according to different user requirements, and a plurality of APP icons corresponding to the plurality of APPs can be displayed on a touch screen of the electronic devices to receive operations (e.g., touch operations) of the user.

### BRIEF DESCRIPTION OF THE DRAWINGS

Implementations of the present technology will now be described, by way of example only, with reference to the attached figures.

FIG. 1 illustrates a block diagram of an example embodiment of an electronic device.

FIG. 2 illustrates a single touch operation applied on an application icon displayed on an touch screen of the electronic device of FIG. 1, according to a first exemplary embodiment.

FIG. 3 illustrates a multi-touch operation applied on an application icon displayed on the touch screen of the electronic device of FIG. 1, according to a second exemplary embodiment.

FIG. 4 illustrates a sliding operation applied on an application icon displayed on the touch screen of the electronic device of FIG. 1, according to a third exemplary embodiment.

FIG. 5 illustrates a sliding operation accompanying a predetermined direction to change and preview an application icon displayed on the touch screen of the electronic device of FIG. 1, according to a fourth exemplary embodiment.

FIG. 6 illustrates an application icon which has been changed via a touch operation of a user.

FIG. 7 illustrates a flowchart of a method for changing an application icon of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising”, when utilized, means “including, but not necessarily limited to”; it specifically indicates open-ended inclusion or membership in the so-described combination, group, series and the like.

The present disclosure is described in relation to an electronic device and a method for changing an application icon displayed on a touch screen of the electronic device.

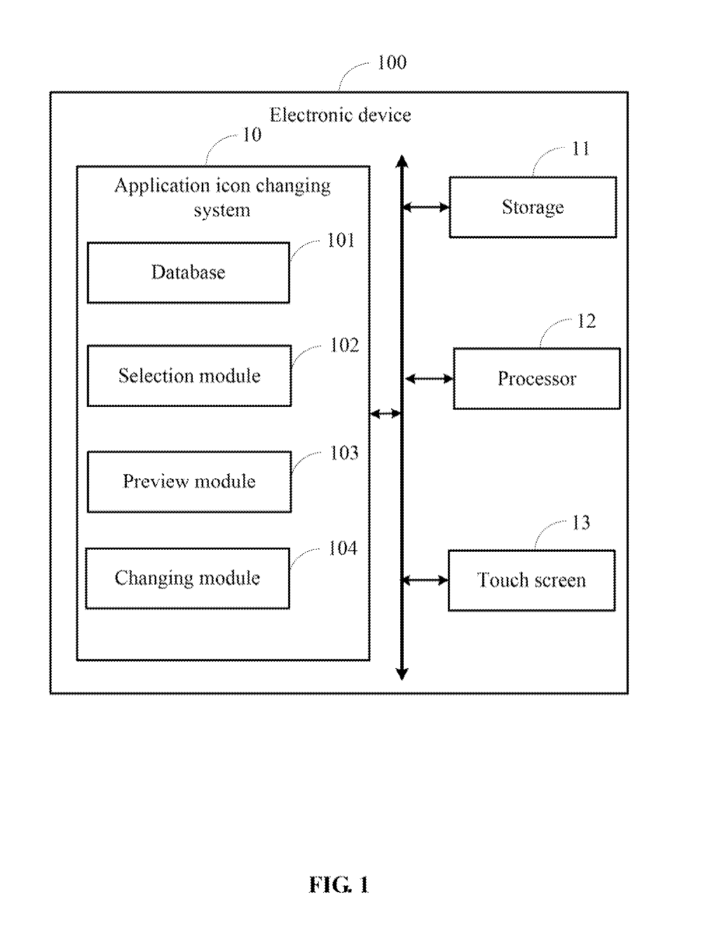

FIG. 1 illustrates a block diagram of an example embodiment of an electronic device 100. In at least one embodiment as shown in FIG. 1, the electronic device 100 can include, but is not limited to, an application icon changing system 10, a storage 11, a processor 12, and a touch screen 13. FIG. 1 illustrates only one example of the electronic device 100, other examples can comprise more or fewer components than those shown in the embodiment, or have a different configuration of the various components.

The processor 12 executes one or more computerized codes and other applications of the electronic device 100 to provide functions of the electronic device 100. The storage 11 can be a non-transitory computer-readable medium and can be an internal storage device, such as a random access memory (RAM) for temporary storage of information, and/or a read only memory (ROM) for permanent storage of information. The storage 11 can also be an external storage device, such as an external hard disk, a storage card, or a data storage medium.

In at least one embodiment, the application icon changing system 10 can include, but is not limited to, a database 101, a selection module 102, a preview module 103, and a changing module 104. The above mentioned modules 101-104 can include computerized instructions in the form of one or more computer-readable programs that can be stored in a non-transitory computer-readable medium, such as the storage 11, and be executed by the processor 12 of the electronic device 100. In at least one embodiment, a plurality of applications (APPs) can be installed on the electronic device 100.

The touch screen 13 can be a resistance touch screen, a capacitance touch screen, an optical touch screen, or an infrared touch screen. The touch screen 13 can display different application icons. Further, the touch screen 13 can detect different touch operations, such as single touch operations, multi-touch operations, or sliding operations, applied on the touch screen 13.

The database 101 is configured to store at least one stand-by icon for serving as an application icon of the APPS. In addition, the at least one stand-by icon can be downloaded from network or any cartographic software. Further, the database 101 receives and stores the at least one stand-by icon input via the touch screen 13.

The selection module 102 is configured to select at least one application icon displayed on the touch screen 13 according to a first touch operation applied on the touch screen 13, and the at least one application icon can be changed to anyone of the at least one stand-by icon stored in the database 101. Detailed descriptions will be illustrated below.

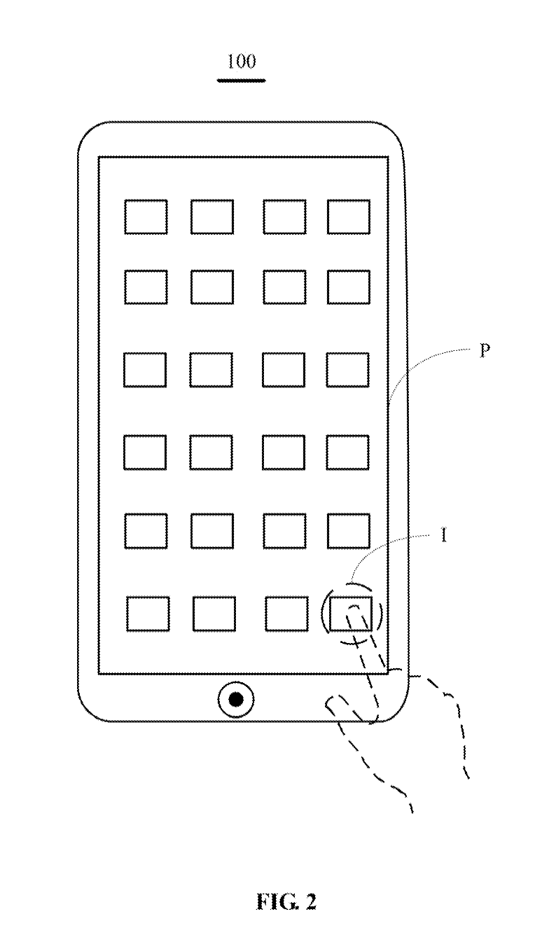

FIG. 2 illustrates the touch screen 13 includes a display interface P, a first touch operation can be applied on the display interface P to select at least one application icon. It should be understood that, the first touch operation can be a single touch operation as shown in FIG. 2, which is configured to click or select at least one application icon to be changed within a virtue circle “I” on the display interface P. Optionally, the at least one application icon includes one application icon selected by the single touch operation.

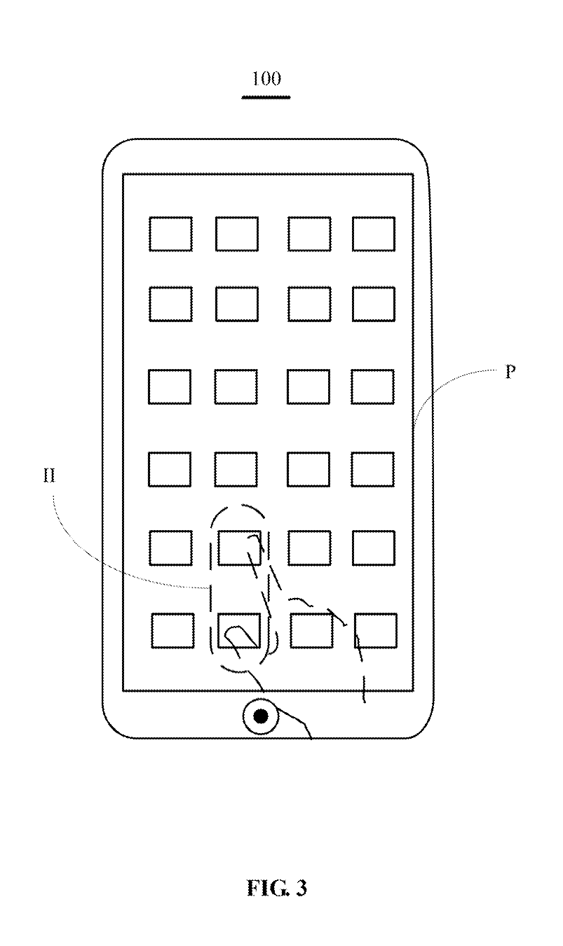

In addition, the first touch operation can be a multi-touch operation as shown in FIG. 3, which is configured to click or select at least one application icon to be changed with a virtue circle “II” on the display interface P. Optionally, the at least one application icon includes one or more application icons selected by the multi-touch operation.

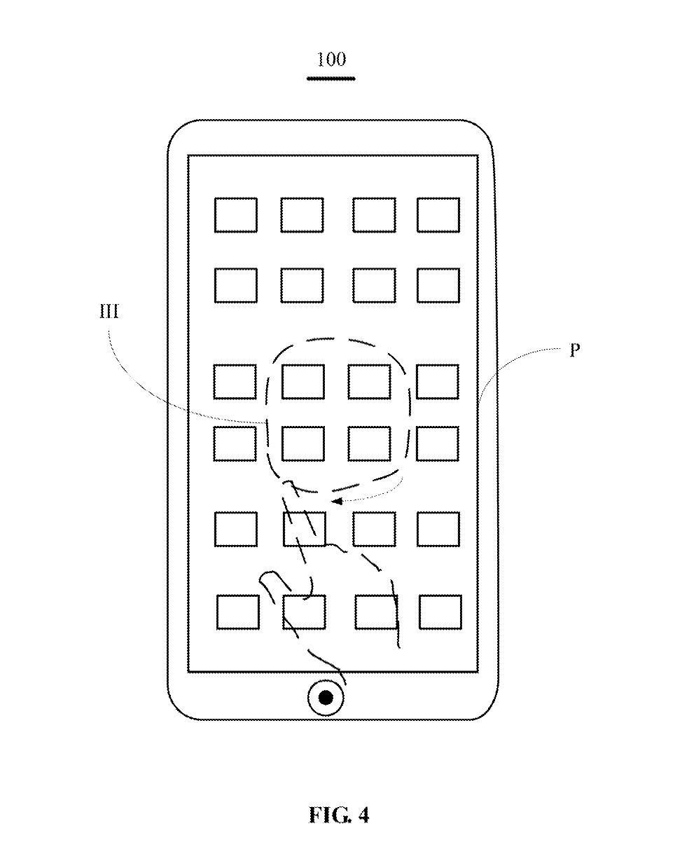

Further, the first touch operation can be a sliding operation as shown in FIG. 4, which is configured to select at least one application icon to be changed with a virtue circle “III” on the display interface P. In other words, the sliding operation can include a gesture that draws a circle on the display interface P and the at least one application icon in the circle is selected. Optionally, the at least one application icon includes one or more application icons selected by the sliding operation.

When the at least one application icon is selected, a display status of the at least one application icon can be changed. For example, the display status of the at least one application icon can be changed from static status display to dynamic display (such as jiggle). In other embodiments, a display status of other application icons which are not selected can also be changed, for example, a color of the other application icons is slightly lighter.

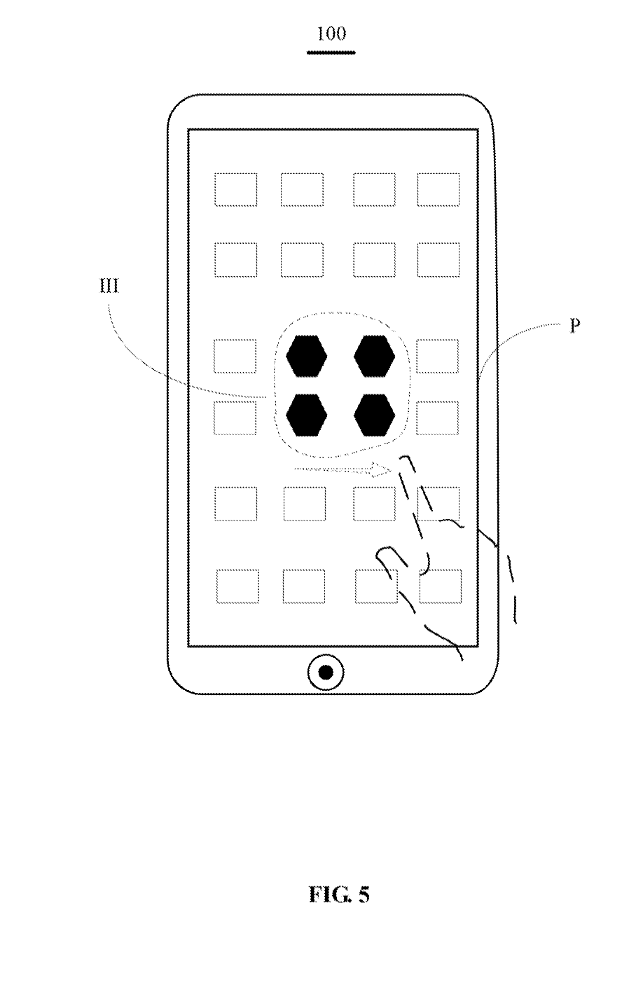

The preview module 103 is configured to switch the at least one stand-by icon stored in the database 101, according to a second touch operation applied on the touch screen 13, to allow the at least one stand-by icon to be alternately displayed in a predetermined area. In at least one embodiment, the second touch operation can be a sliding operation accompanying a predetermined direction. The predetermined area can be a region where the at least one application icon is located in, such as the virtue circles “I”, “II”, or “III”. The predetermined direction includes a first direction (from left to right) and a second direction opposite to the first direction. Referring to FIG. 5, when the at least one application icon is selected, a sliding operation accompanying the first direction is applied on the predetermined area (for example, the region of the virtue circle “III”) to switch the at least one stand-by icon stored in the database 101. Thus, the at least one stand-by icon stored in the database 101 can be previewed in response to the sliding operation of the user.

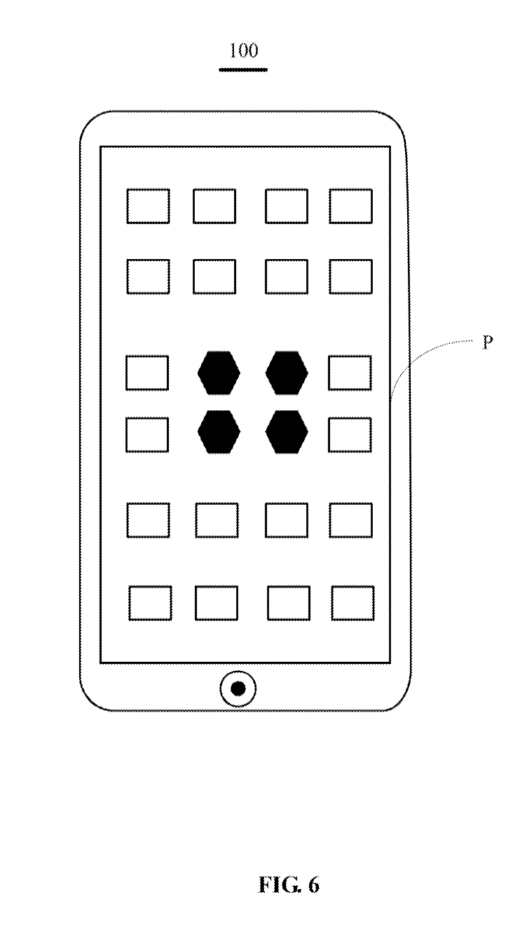

The changing module 104 is configured to changed the at least one application icon selected by the selection module 102 to the at least one stand-by icon displayed on the predetermined area according to a third touch operation applied on the touch screen 13. In at least one embodiment, the third touch operation can be a signal touch operation or a multi-touch operation applied beyond the predetermined area for a predetermined period of time. Referring to FIG. 6, the at least one stand-by icon displayed on the predetermined area is selected via the third touch operation to replace the at least one application icon. In at least one embodiment, the at least one stand-by icon is regular hexagon.

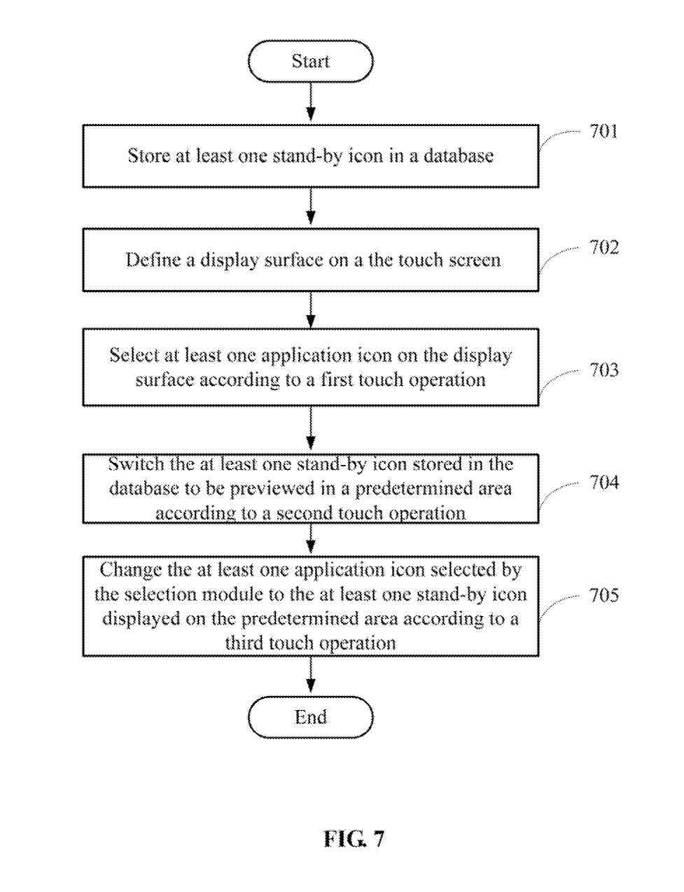

FIG. 7 illustrates a flowchart of a method for changing an application icon of the electronic device 100 of FIG. 1. The method is provided by way of example, as there are a variety of ways to carry out the method. Each block shown in FIG. 7 represents one or more processes, methods, or subroutines which are carried out in the example method. Furthermore, the order of blocks is illustrative only and the order of the blocks can change. Additional blocks can be added or fewer blocks may be utilized without departing from the scope of this disclosure. The example method can begin at block 701.

At block 701, a database stores at least one stand-by icon. The at least one stand-by icon can be downloaded from network or any cartographic software, or can be input by a user via a touch screen.

At block 702, the touch screen defines a display surface for displaying at least one application icon.

At block 703, a selection module selects the at least one application icon according to a first touch operation applied on the display surface. Optionally, the display status of the at least one application icon selected by the selection module is changed.

At block 704, a preview module switches the at least one stand-by icon stored in the database, according to a second touch operation, to allow the at least one stand-by icon to be alternately displayed in a predetermined area. Thus, the at least one stand-by icon can be previewed to facilitate selection.

At block 705, a changing module changes the at least one application icon selected by the selection module to the at least one stand-by icon displayed on the predetermined area according to a third touch operation. At this time, the at least one stand-by icon replaces the at least one application icon.

In summary, the application icon changing system 10 of the electronic device 100 can selectively change the application icon displayed on the touch screen 13 according different touch operations, thereby satisfying different user requirements.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device comprising:
a touch screen;
a processor coupled to the touch screen; and
a storage coupled to the processor and configured to store one or more programs executed by the processor, the one or more programs causing the processor to:
store at least one stand-by icon;
select at least one application icon displayed on the touch screen according to a first touch operation;
switch the at least one stand-by icon stored in the database to be previewed in a predetermined area according to a second touch operation;
change the at least one application icon to the at least one stand-by icon previewed on the predetermined area according to a third touch operation.

2. The electronic device according to claim 1, wherein the predetermined area is a region where the at least one application icon is located in.

3. The electronic device according to claim 1, wherein the first touch operation is a single touch operation, and the at least one application icon comprises one application icon selected by the single touch operation.

4. The electronic device according to claim 1, wherein the first touch operation is a multi-touch operation, and the at least one application icon comprises one or more application icons selected by the multi-touch operation.

5. The electronic device according to claim 1, wherein the first touch operation is a sliding operation, and the at least one application icon comprises one or more application icons selected by the sliding operation.

6. The electronic device according to claim 1, wherein the second touch operation is a sliding operation accompanying a predetermined direction.

7. The electronic device according to claim 1, wherein the third touch operation is a signal touch operation or a multi-touch operation applied beyond the predetermined area for a predetermined period of time.

8. The electronic device according to claim 1, wherein the database receives and stores the at least one stand-by icon input via the touch screen.

9. A method for changing an application icon of an electronic device having a touch screen, the method comprising:
storing at least one stand-by icon in a database;
selecting at least one application icon on the touch screen according to a first touch operation;
switching the at least one stand-by icon stored in the database, according to a second touch operation, to allow the at least one stand-by icon to be alternately displayed in a predetermined area;
changing the at least one application icon to the at least one stand-by icon displayed on the predetermined area according to a third touch operation.

10. The method according to claim 9, wherein the predetermined area is a region where the at least one application icon is located in.

11. The method according to claim 9, wherein the first touch operation is a single touch operation, and the at least one application icon comprises one application icon selected by the single touch operation.

12. The method according to claim 9, wherein the first touch operation is a multi-touch operation, and the at least one application icon comprises one or more application icons selected by the multi-touch operation.

13. The method according to claim 9, wherein the first touch operation is a sliding operation, and the at least one application icon comprises one or more application icons selected by the sliding operation.

14. The method according to claim 9, wherein the second touch operation is a sliding operation accompanying a predetermined direction.

15. The method according to claim 9, wherein the third touch operation is a signal touch operation or a multi-touch operation applied beyond the predetermined area for a predetermined period of time.

16. The method according to claim 9, further comprising receiving and storing the at least one stand-by icon input via the touch screen.
